(19) United States
(12) Patent Application Publication
(10) Pub. No.: US 2026/0210889 A1
(43) Pub. Date: Jul. 23, 2026

(54) DETECTING MICROCRACKS IN A SEMICONDUCTOR DIE

(71) Applicant: Sandisk Technologies, Inc., Milpitas, CA (US)

(72) Inventors: Ching Yoong Ang, Bukit Mertajam (MY); Syed Mohd Ikmal Syed Amir, Bukit Mertajam (MY); Amzar Norkhalid, Simpang Ampat (MY)

(21) Appl. No.: 19/029,740

(22) Filed: Jan. 17, 2025

(51) Int. Cl. G01N 25/72

(52) U.S. Cl. CPC G01N 25/72

(57) ABSTRACT

A microcrack detection system detects cracks and/or microcracks within a semiconductor die and/or within a semiconductor package. The microcrack detection system applies an electrical current to the semiconductor die. The electrical current causes a temperature of the semiconductor die to increase. One or more thermal sensors are used to determine a thermal profile of the semiconductor die. The thermal profile is analyzed to determine whether cracks or defects exist within the semiconductor die.

### BACKGROUND

Cracks or internal defects within semiconductor packages and/or semiconductor dies (e.g., memory dies) negatively impact the functionality of the semiconductor die and often render the semiconductor die unusable. These cracks or defects may have several potential root causes. For example, cracking may occur during a pick-and-place (PnP) machine process, during a molding process, during a dicing or a sawing process and so on.

If cracks or defects are not detected during fabrication or assembly, it is possible that the cracks will get worse. For example, the cracks may get worse during shipping and/or as a result of the semiconductor die being exposed to high operating temperatures. As the cracks get worse, the performance of the semiconductor die will be negatively impacted. For example, if the semiconductor die is a memory die, such as a NAND memory die, data stored in the memory die may become corrupted or even lost. In other examples, the memory die may cease functioning all together.

Current prevention and detection methods typically involve frequent maintenance on the various machines and equipment that are used during fabrication and assembly. Visual inspections are also used. However, these methods are inefficient and time-consuming and some cracks may still go undetected.

Accordingly, it would be beneficial to detect cracks and/or internal defects within a semiconductor die in a manner that is more efficient and effective when compared with current solutions.

### SUMMARY

This disclosure describes a microcrack detection system that detects cracks and/or microcracks within a semiconductor die and/or within a semiconductor package. As will be described in more detail herein, the microcrack detection system applies an electrical current to various probes provided on a semiconductor die or on the semiconductor package. In another example, the electrical current may be directly applied to the semiconductor die or the semiconductor package. The electrical current causes a temperature of the semiconductor die and/or the semiconductor package to increase. The probes may remain on the semiconductor die and/or the semiconductor package or they may be removed. One or more thermal sensors are used to determine a thermal profile (e.g., a heat map) of the semiconductor die and/or the semiconductor package. The thermal profile is analyzed to determine whether cracks or defects exist within the semiconductor die and/or the semiconductor package.

Accordingly, examples of the present disclosure describe a method for detecting cracks in a semiconductor die and/or a semiconductor package. In an example, the method includes applying an electrical current to a plurality of probes provided on at least one semiconductor die. The method also includes thermally scanning an area of the at least one semiconductor die for one or more thermal variations. The method additionally includes generating a heat map based, at least in part, on the one or more thermal variations and analyzing the heat map to determine whether any of the one or more thermal variations exceeds a thermal variation threshold. Further, the method may include identifying a microcrack based, at least in part, on a determination that at least one thermal variation exceeds the thermal variation threshold.

The present disclosure also describes a method for detecting cracks in a semiconductor die and/or a semiconductor package. In an example, the method includes positioning a plurality of probes on at least one semiconductor die and providing an electrical current through the plurality of probes to induce localized heating of the at least one semiconductor die. The method may also include removing the plurality of probes from the at least one semiconductor die and scanning a scanning area of the at least one semiconductor die to collect thermal data associated with the scanning area. Further, the method may include generating a heat map based, at least in part, on the thermal data and analyzing the heat map to detect thermal variations that exceed a thermal variation threshold value to detect a microcrack.

Still other examples describe a system that includes means for inducing localized heating of a semiconductor die and means for measuring a surface temperature the semiconductor die. The system also includes means for generating a heat map based, at least in part, on the surface temperature of the semiconductor die and means for analyzing the heat map to detect a crack within the at least one memory die. The system may be capable of performing any of the methods described herein.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

Non-limiting and non-exhaustive examples are described with reference to the following Figures.

FIG. 1A illustrates a semiconductor package that will undergo a microcrack detection process using a microcrack detection system according to an example.

FIG. 1B illustrates the semiconductor package of FIG. 1A with a plurality of probes positioned about the semiconductor package according to an example.

FIG. 1C illustrates an electric current being provided to the plurality of probes according to an example.

FIG. 1D illustrates a thermal sensor measuring a temperature of the semiconductor die of the semiconductor package according to an example.

FIG. 2 illustrates a heat map that is generated using thermal information provided by a thermal sensor according to an example.

FIG. 3 illustrates a method for detecting cracks within a semiconductor die according to another example.

FIG. 4 illustrates a method for detecting cracks within a semiconductor die according to another example.

FIG. 5 is a system diagram of a computing device according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

As previously described, cracks and/or internal defects within semiconductor packages and/or semiconductor dies negatively impact the functionality of the semiconductor die and/or the semiconductor package. While the cause of these cracks and defects may vary, current detection methods are insufficient. This is generally due to the relatively minor nature of cracks or defects present within the semiconductor dies and/or the semiconductor packages.

To address the above, the present disclosure describes a microcrack detection system that detects cracks or microcracks in a semiconductor package and/or a semiconductor die. In some examples, the microcrack detection system detects cracks as small as five microns (or less). To detect the presence of a microcrack, a plurality of probes (e.g., silicon probes) are positioned on the semiconductor die. An electrical current is then provided to the probes, or through a connector associated with the semiconductor package, which causes the temperature of the semiconductor die to rise. The probes may remain on the semiconductor die or may be removed. A thermal sensor is positioned above the semiconductor die. The thermal sensor is used to detect temperature variations within the semiconductor die. For example, the thermal sensor collects temperature data and generates thermal profile or a heat map that visually represents the temperature variations across the semiconductor die. Areas with abnormal heat signatures are identified and indicate the potential presence of cracks.

Accordingly, many technical benefits may be realized by the present disclosure and examples contained herein. Beneficially, the disclosed examples are capable of detecting minor cracks, thereby preventing defective dies from being shipped to consumers and, ultimately, discarded as electronic waste. Additionally, the disclosed systems and methods are capable of visually communicating the presence of cracks and the location of the cracks within the at least one memory die. By ensuring application of currents ranging from ten microamps (μA) to one hundred μA, minimal heat generation, and controlled scanning, the disclosed technique can effectively detect microcracks without compromising the integrity or performance of the memory dies.

Additional advantages of the present disclosure include providing a budget-friendly solution for thermal scanning and defect detection. For example, the thermal scanning techniques described herein may be accomplished in four seconds or less, two seconds or less than two seconds per die. As a result, efficient defect detection will occur without creating bottlenecks in the semiconductor package assembly process. Further, the microcrack detection system described herein delivers a high-resolution heat map with a precision of five microns and can detect defects as small as ten microns. This level of detail ensures accurate detection of internal defects by directly correlating electrical resistance to material integrity.

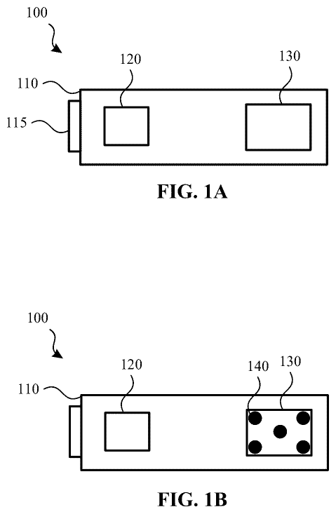

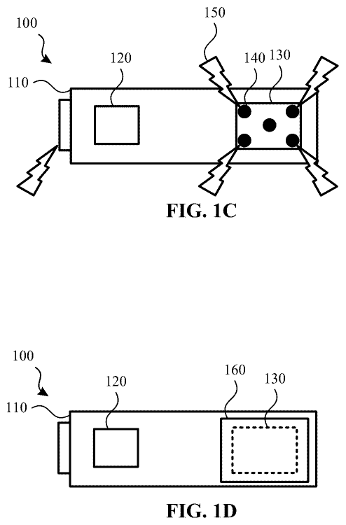

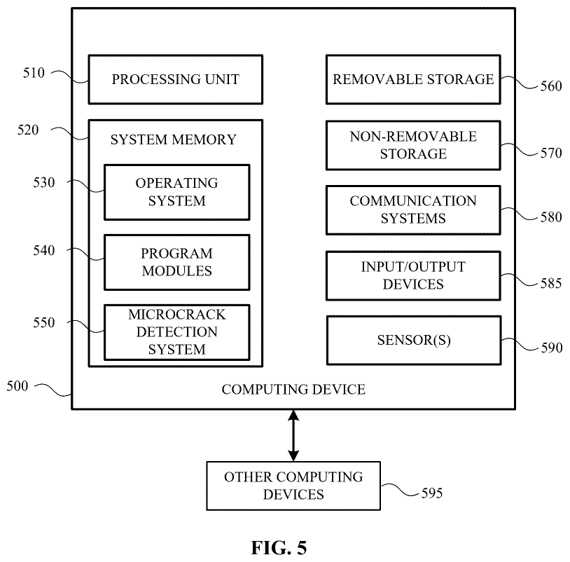

These and other examples will be shown and described in greater detail with respect to FIG. 1A - FIG. 5.

FIG. 1A illustrates a semiconductor package 100 that will undergo a microcrack detection process using a microcrack detection system according to an example. The semiconductor package 100 may be any type of semiconductor package and have various electronic components mounted on, or coupled to, a substrate or a printed circuit board (PCB) 110. For example, the semiconductor package 100 includes an integrated circuit 120 and a semiconductor die 130. The semiconductor package 100 may also include a connector 115 (e.g., pins or other contacts) that enable the semiconductor package 100 to be coupled to another PCB and/or a computing device.

In this example, the semiconductor package 100 is a memory device, such as, for example, a NAND memory device. As such, the integrated circuit 120 may be a controller and the semiconductor die 130 may be a memory die, such as, for example, a NAND memory die. Although a controller and a memory die are specifically mentioned, the semiconductor package 100 may include additional or fewer electronic components.

FIG. 1B illustrates the semiconductor package 100 of FIG. 1A with a plurality of probes 140 positioned about the semiconductor package 100 according to an example. In an example, the plurality of probes 140 are silicon probes. In an example, silicon probes are used due to their thermal and electrical conductivity, precision, durability, and compatibility with semiconductor setups. Although silicon probes are mentioned, other types of probes may be used. For example, conductive silicone probes can be used for gentle contact, metallic probes can be used for higher current capacities, carbon-based probes can be used for high conductivity, and polymer-coated probes can be used to prevent oxidation. In another example, the electrical current can be provided to/through the connector 115.

The plurality of probes 140 are positioned at different locations on the semiconductor die 130. For example, a first probe is positioned proximate a first edge or corner of the semiconductor die 130, a second probe is positioned proximate a second edge or corner of the semiconductor die 130, a third probe is positioned proximate a third edge or corner of the semiconductor die 130 and a fourth probe is positioned proximate a fourth edge or corner of the semiconductor die 130. In addition, a fifth probe is positioned at or near a center of the semiconductor die 130. Although five probes are shown and described, additional or fewer probes 140 may be used.

FIG. 1C illustrates an electric current 150 being provided to the plurality of probes 140 according to an example. The electric current 150 is used to induce localized heating on the semiconductor die 130. Further, the probes 140 are placed at the various corners and in the center of the semiconductor die 130 to maximize coverage and to help ensure stable current flow throughout the process described herein. In an example, the electrical current is a low-level electrical current between ten microamps (μA) and one hundred μA. Although a specific range is given, other values may be used, so long as the applied electrical current does not damage the semiconductor die 130.

FIG. 1D illustrates a thermal sensor 160 measuring a temperature of the semiconductor die 130 of the semiconductor package 100 according to an example. The thermal sensor 160 is placed over the semiconductor die 130 once the plurality of probes 140 have been removed from the surface of the semiconductor die 130. In another example, the probes 140 may remain on the surface. In an example, the thermal sensor 160 is positioned above the surface of the semiconductor die 130 and captures temperature information in real time or substantially real time. This proximity enhances the sensitivity of the thermal sensor 160 and enables the thermal sensor 160 to capture detailed thermal data across a scanning area.

In an example, the thermal sensor 160 is a high-speed thermal sensor, capable of providing a response in microseconds or less. Additionally, the thermal sensor 160 continuously monitors a thermal profile of the semiconductor die 130 across the entire (or partial) surface of the semiconductor die 130.

In an example, the thermal sensor 160 is an array of thermal sensors that have the ability to scan multiple regions of the semiconductor die 130 at the same time. For example, if the thermal sensor 160 includes an array of eight sensors, the array can cover an area of twenty millimeters (mm) by twenty mm at the same time, thereby reducing an overall temperature scanning time. In an example, the thermal sensor 160 performs thermal scanning in four seconds or less, two seconds or less than two seconds. Although a specific number of sensors in the array of sensors is mentioned, and a specific scanning area is mentioned, fewer or additional sensors may be used to capture a larger or a smaller scanning area.

In an example a resolution of the thermal scanner 160 may be coarse or fine. In an example, coarse scanning resolution typically involves fewer scanning points across the surface, such as a resolution of twenty mm by twenty mm, which focuses on larger surface areas with less detail. Fine scanning resolution involves a higher density of scanning points and captures more detailed thermal variations. In an example, fine scanning may include resolutions of five mm by five mm or less and even down to one mm by one mm. Coarse resolution is useful for rapid screening and detecting significant anomalies, while fine resolution is used for detailed analysis of smaller defects or microcracks. In some examples, a coarse scanning resolution reduces the number of scanning points when compared to a fine scanning resolution. In addition, if the thermal scanner 160 has a high frame rate, the thermal scanner 160 continuously monitors the thermal profile across the surface of the semiconductor die 130.

In an example, a computing device associated with the thermal sensor 160 collects the temperature information and generates a heat map or other visualization. The heat map visually represents temperature variations across the semiconductor die 130. The computing device may also determine whether a temperature variation detected by the thermal sensor 160 and/or displayed in the heat map is above a temperature variation threshold. In an example, a temperature variation threshold exceeding 10° C. is considered abnormal. Although a specific value is given, other thresholds may be used. In an example, the temperature variation threshold applies when comparing localized areas on the semiconductor die to surrounding regions or the expected uniform thermal profile. An “abnormal heat signature” includes localized hot spots with temperature deviations over 10° C., disrupted uniformity in temperature distribution, and persistent or significant temperature spikes exceeding 10° C. under controlled conditions. In an example, areas with abnormally high heat signatures, or areas that are above the temperature variation threshold indicating potential internal cracks.

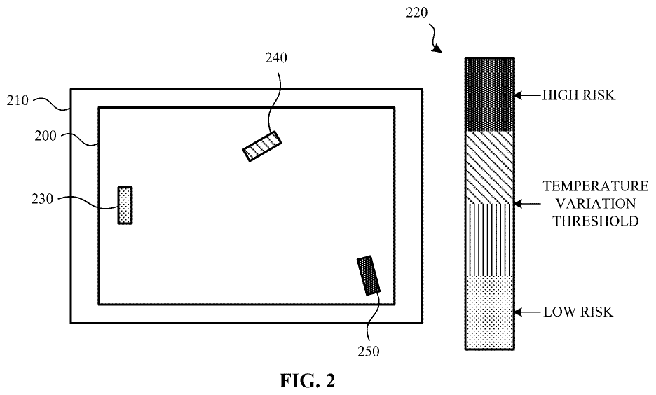

FIG. 2 illustrates a heat map 200 that is generated using thermal information provided by a thermal sensor according to an example. In an example, the thermal sensor that provides the thermal information from which the heat map 200 is generated is the thermal sensor 160 shown and described with respect to FIG. 1D. Although a heat map 200 is specifically mentioned, the thermal information may be used to generate any type of visualization.

In an example, the thermal information is provided to a computing device 210 and the computing device 210 generates and/or displays the heat map 200. In an example, the computing device 210 also controls the thermal sensor and/or the electrical current that is applied to the various probes (e.g., the plurality of probes 140) that are provided on a surface of a semiconductor die (e.g., the semiconductor die 130 (FIG. 1A)). In an example, the computing device 210 may also control the placement of and/or the removal of, the plurality of probes.

In the example shown in FIG. 2, the thermal information provided to the computing device 210 indicates that there are three areas with thermal variations—a first area 230, a second area 240 and a third area 250. A severity of the each of the areas with thermal variations is illustrated in the legend or key 220. In an example, the severity indicates a risk of a crack, or the potential of there being a crack, in the semiconductor die.

For example, the key 220 includes four patterns or colors that scale from a high risk to a low risk. The key 220 also indicates a temperature variation threshold. Although the temperature variation threshold is positioned at a certain location on the key 220, the temperature variation threshold may have any value. In an example, any areas that have a color code or a pattern above the temperature variation threshold, have a high risk of being (or indicating) a crack in the semiconductor die. However, any areas that have a color or a pattern below the temperature variation threshold have a low risk of being (or indicating) a crack in the semiconductor die.

As previously indicated, the heat map 200 shows three areas with thermal variations—the first area 230, the second area 240 and the third area 250. When comparing the pattern or colors in each area to the key 220, the computing device 210 can determine which areas on the semiconductor die are at risk for cracking or potentially have a crack.

For example, the first area 230 is at a low risk of having a crack because the pattern or color associated with the first area 230 is below the temperature variation threshold in the key 220. However, the second area 240 and the third area 250 are at a high risk of having a crack because the pattern or color associated with each of these areas is above the temperature variation threshold.

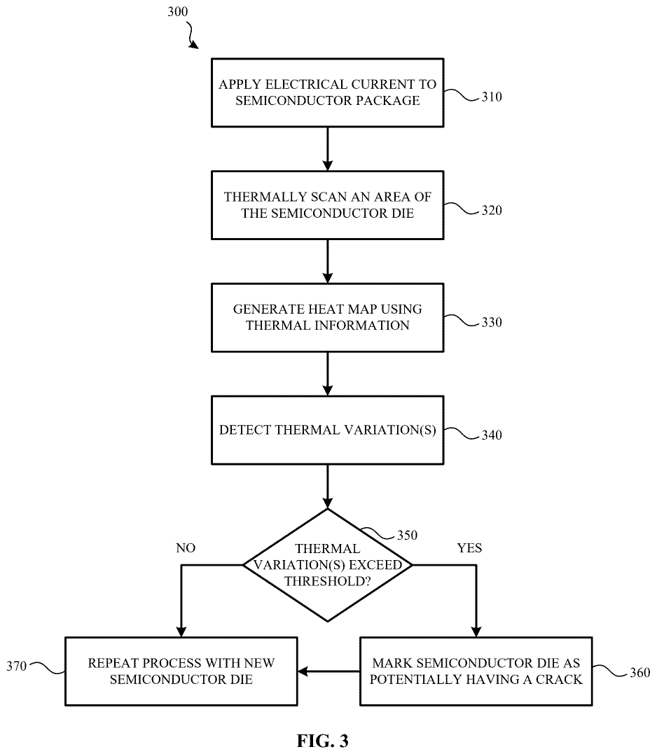

FIG. 3 illustrates a method 300 for detecting cracks in a semiconductor die according to an example. In an example, the semiconductor die may be part of a semiconductor package such as, for example, the semiconductor package 100 shown and described with respect to FIG. 1A-FIG. 1D. In addition, the method 300 may be performed, or partially performed, by a computing device associated with, or having a microcrack detection system and/or the various probes and/or thermal sensor(s) previously described.

In an example, the method 300 begins when an electrical current is applied (310) to a plurality of probes on a semiconductor die and/or on a semiconductor package. The electrical current applied to the plurality of probes may be a low-level current having a range between ten μA and one hundred μA. In an example, applying a low-level current under low voltage conditions (e.g., less than one volt) results in minimal power dissipation and amounts to microwatts (μW) of energy, which will not cause any thermal and/or electrical stress on the semiconductor die. Additionally, the current creates a localized and minimal temperature variation (e.g., less than one degree Celsius), which is far below a heat threshold a semiconductor die can withstand.

In an example, the plurality of probes are conductive silicone probes. Additionally, the plurality of probes are positioned at a number of different locations on the semiconductor die. For example, a first probe of the plurality of probes is positioned at a first location on the semiconductor die and a second probe of the plurality of probes is positioned at a second location on the semiconductor die, where the second location is different than the first location. For example, the first location is at or proximate a corner of the semiconductor die and the second location is at or proximate a different corner of the at least one memory die. In another example, the first location is at or proximate to a corner of the semiconductor die and the second location is at or proximate a center of the semiconductor die. Additionally, the current can also be applied through a connector.

When the electrical current has been applied to the plurality of probes, the probes may be removed from the semiconductor die or may remain. A thermal sensor or a thermal scanner thermally scans (320) the semiconductor die. In an example, the thermal sensor is scanning for one or more thermal variations on an area of the semiconductor die.

In one example, thermally scanning the area of the semiconductor die for one or more thermal variations includes positioning at least one thermal sensor above the semiconductor die and/or moving the thermal sensor from a first position to a second position. In another example, the thermal sensor remain stationary.

When the semiconductor die has completed the scanning operation (or during the scanning operation) the thermal information is provided to a computing device or a processing device and a heat map (or other visualization) is generated (330) using the thermal information. For example, the heat map is generated based on thermal measurements taken of the surface of the semiconductor die after the electrical current has been applied to the semiconductor die.

During generation of the heat map, or upon completion of the heat map, thermal variations are detected. In an example, the thermal variations are detected using a processor and/or a computing device. For example, the processor or the computing device identifies a baseline temperature of the semiconductor die (e.g., a temperature at which a majority or over a threshold area of the semiconductor die has) and compares temperature readings of other areas to the baseline temperature to determine or identify areas that are above the baseline temperature. In another example, the thermal variations are visually detected or identified.

In response to detecting thermal variations, a determination (350) is made as to whether the thermal variations exceed a thermal variation threshold such as previously described. If it is determined (350) that any of the thermal variations exceed the thermal variation threshold, the semiconductor die is flagged or marked (360) as having a crack, a microcrack and/or potentially having a crack/microcrack. The method 300 is then repeated (370) with a new semiconductor die.

However, if it is determined (350) that none of the thermal variations exceed the thermal variation threshold, the semiconductor die is cleared and the method 300 may then be repeated (370) with a new semiconductor die.

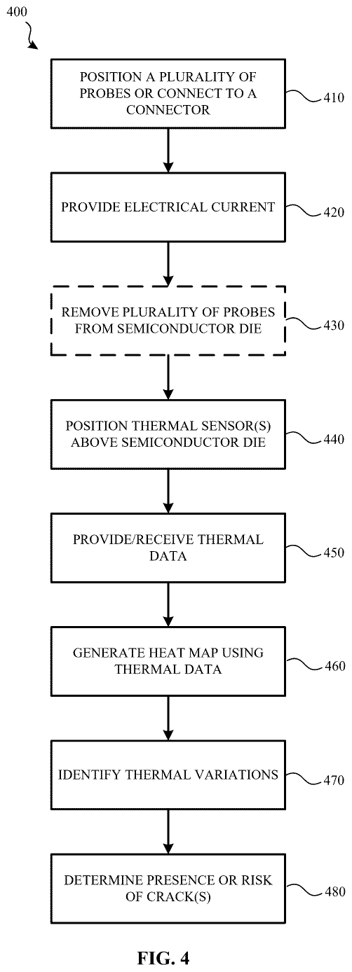

FIG. 4 illustrates a method 400 for detecting cracks within a semiconductor die according to another example. In an example, the semiconductor die may be part of a semiconductor package such as, for example, the semiconductor package 100 shown and described with respect to FIG. 1A-FIG. 1D. In addition, the method 400 may be performed, or partially performed by a computing device associated with, or having a microcrack detection system and/or the various probes and/or thermal sensor(s) previously described.

In an example, the method 400 begins when a plurality of probes is positioned (410) on the semiconductor die or a semiconductor package associated with the semiconductor die is connected to a connector (e.g., via a connector of the semiconductor package). As previously explained, a first probe of the plurality of probes is positioned at a first location on the semiconductor die and a second probe of the plurality of probes is positioned at a second location on the semiconductor die.

In response to the probes being placed or the semiconductor package being connected to a connector, an electrical current is provided (420) to the plurality of probes or optionally, the current can be applied through a connector. In an example, the electrical current induces localized heating of the semiconductor die.

When a desired temperature is reached, or after a predetermined (or determined) amount of time, the plurality of probes are (optionally) removed (430) from the semiconductor die. A thermal sensor (or an array of thermal sensors) is then positioned (440) over or on the semiconductor die. The thermal sensor scans the semiconductor die, or a scanning area of the semiconductor die, to collect thermal data.

The thermal data is provided to and/or received (450) by a computing device. In an example, the thermal data is received in real time or substantially real time (e.g., as the thermal sensor is scanning the semiconductor die). In another example, the thermal data is received upon completion of the scanning operation.

In an example, the computing device that receives the thermal data is the same computing device that executes the method 400. In another example, the computing device that receives the thermal data is a different computing device.

In response to receiving the thermal data, a heat map is generated (460). In an example, the computing device generates the heat map as the thermal data is received. In another example, the heat map is generated upon completion of the scanning operation.

In response to generating the heat map (or while the heat map is being generated), thermal variations (if any) are identified (470). Using the thermal variations, the presence or risk of cracks in the semiconductor die is determined (480) such as previously described. For example, the computing device determines whether the thermal variations exceed a thermal variation threshold.

FIG. 5 is a system diagram of a computing device 500 according to an example. In an example, the computing device 500 is similar to the computing device 210 shown and described with respect to FIG. 2. The computing device 500, or various components and systems of the computing device 500, may be integrated or associated with a microcrack detection system such as described herein. For example, the computing device 500, or various components or systems of the computing device 500, such as the microcrack detection system 550, may be used to place the plurality of probes, apply an electrical current to the plurality of probes, or the current can be applied through a connector, provide and/or receive temperature data, control one or more thermal sensors, generate a heat map or other visualization, detect thermal variations and/or determine whether the thermal variations exceed a thermal variation threshold.

As shown in FIG. 5, the physical components (e.g., hardware) of the computing device are illustrated and these physical components may be used to practice the various aspects of the present disclosure.

The computing device 500 includes at least one processing unit 510 and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540. The program modules 540, either alone, or in combination with, the microcrack detection system 550, may be responsible for executing one or more operations of a microcrack detection process such as described herein and/or marking a semiconductor die as potentially having cracks. While being executed by the processing unit 510, the program modules 540 may perform the various processes described herein.

The computing device 500 may also have additional features or functionality. For example, the computing device 500 may include additional data storage devices (e.g., removable and/or non-removable storage devices) such as, for example, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 500 on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems 580 that enable the computing device 500 to communicate with other computing devices 595 or systems. In another example, the communication systems 580 enable the computing device 500 to receive temperature data and/or provide temperature data to another computing device. Examples of communication systems 580 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 500 may also have one or more input devices and/or one or more output devices shown as input/output devices 585. These input/output devices 585 may include a keyboard, a sound or voice input device, haptic devices, a touch, force and/or swipe input device, a display, speakers, etc. The aforementioned devices are examples and others may be used. In an example, the input/output devices 585 may be used to generate and/or display a heat map or other visualization.

The computing device 500 may also include one or more sensors 590. The sensors may be thermal sensors/scanners that are used to detect a temperature of semiconductor die and/or a semiconductor package.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500.

Accordingly, examples of the present disclosure describe a method, comprising: applying an electrical current to a semiconductor die; thermally scanning an area of the semiconductor die for one or more thermal variations; generating a heat map based, at least in part, on the one or more thermal variations; analyzing the heat map to determine whether any of the one or more thermal variations exceeds a thermal variation threshold; and identifying a microcrack based, at least in part, on a determination that at least one thermal variation exceeds the thermal variation threshold. In an example, applying the electrical current to the semiconductor die comprises: positioning a plurality of probes on the semiconductor die; and providing the electrical current to the plurality of probes. In an example, positioning the plurality of probes on the semiconductor die comprises positioning a first probe of the plurality of probes at a first location on the semiconductor die and positioning a second probe of the plurality of probes at a second location on the semiconductor die, the second location being different than the first location. In an example, the first location comprises a corner of the semiconductor die and the second location comprises a center of the semiconductor die. In an example, the electrical current is in a range between ten microamps (μA) and one hundred μA. In an example, the thermal variations are identified based, at least in part, by comparing a temperature reading to a baseline temperature. In an example, thermally scanning the area of the semiconductor die for the one or more thermal variations comprises: positioning at least one thermal sensor above the semiconductor die; causing the thermal sensor to scan the area; and collecting thermal data across the scanning area. In an example, applying the electrical current to the semiconductor die comprises applying the electrical current to a connector associated with the semiconductor die. In an example, the thermal scanning is complete in four seconds or less.

Other examples describe a method, comprising: positioning a plurality of probes on at least one semiconductor die; providing an electrical current through the plurality of probes to induce localized heating of the at least one semiconductor die; removing the plurality of probes from the at least one semiconductor die; scanning a scanning area of the at least one semiconductor die to collect thermal data associated with the scanning area; generating a heat map based, at least in part, on the thermal data; and analyzing the heat map to detect thermal variations that exceed a thermal variation threshold value to detect a microcrack. In an example, generating the heat map comprises generating a visual representation of the collected thermal data with a precision of five microns. In an example, the precision of five microns facilitates detection of internal cracks as small as ten microns. In an example, the electrical current is in a range between ten microamps (μA) and one hundred μA. In an example, the thermal variations are identified based, at least in part, by comparing a temperature reading to a baseline temperature. In an example, positioning the plurality of probes on the at least one semiconductor die comprises positioning a first probe of the plurality of probes proximate an edge of the at least one semiconductor die and positioning a second probe of the plurality of probes proximate a center of the at least one semiconductor die.

Examples also describe a system, comprising: means for inducing localized heating of a semiconductor die; means for measuring a surface temperature the semiconductor die; means for generating a heat map based, at least in part, on the surface temperature of the semiconductor die; and means for analyzing the heat map to detect a crack within the at least one memory die. In an example, the means for inducing localized heating of the semiconductor die comprise a plurality of conductive probes. In an example, the means for measuring the surface temperature of the semiconductor die comprise at least one thermal sensor. In an example, the means for analyzing the heat map to detect a crack within the semiconductor die detects cracks as small as ten microns. In an example, the crack is detected based, at least in part, on a comparison between a temperature reading of an area of the semiconductor die to a baseline temperature.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” and/or “substantially” as applied to a particular value of a range applies to both values, and unless otherwise dependent on the precision of the instrument measuring the value, may indicate +/−10% of the stated value(s).

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed:

1. A method, comprising:
applying an electrical current to a semiconductor die;
thermally scanning an area of the semiconductor die for one or more thermal variations;
generating a heat map based, at least in part, on the one or more thermal variations;
analyzing the heat map to determine whether any of the one or more thermal variations exceeds a thermal variation threshold; and
identifying a microcrack based, at least in part, on a determination that at least one thermal variation exceeds the thermal variation threshold.

2. The method of claim 1, wherein applying the electrical current to the semiconductor die comprises:
positioning a plurality of probes on the semiconductor die; and
providing the electrical current to the plurality of probes.

3. The method of claim 2, wherein positioning the plurality of probes on the semiconductor die comprises positioning a first probe of the plurality of probes at a first location on the semiconductor die and positioning a second probe of the plurality of probes at a second location on the semiconductor die, the second location being different than the first location.

4. The method of claim 3, wherein the first location comprises a corner of the semiconductor die and the second location comprises a center of the semiconductor die.

5. The method of claim 2, wherein the electrical current is in a range between ten microamps (μA) and one hundred μA.

6. The method of claim 1, wherein the thermal variations are identified based, at least in part, by comparing a temperature reading to a baseline temperature.

7. The method of claim 1, wherein thermally scanning the area of the semiconductor die for the one or more thermal variations comprises:
positioning at least one thermal sensor above the semiconductor die;
causing the thermal sensor to scan the area; and
collecting thermal data across the scanning area.

8. The method of claim 1, wherein applying the electrical current to the semiconductor die comprises applying the electrical current to a connector associated with the semiconductor die.

9. The method of claim 1, wherein the thermal scanning is complete in four seconds or less.

10. A method, comprising:
positioning a plurality of probes on at least one semiconductor die;
providing an electrical current through the plurality of probes to induce localized heating of the at least one semiconductor die;
removing the plurality of probes from the at least one semiconductor die;
scanning a scanning area of the at least one semiconductor die to collect thermal data associated with the scanning area;
generating a heat map based, at least in part, on the thermal data; and
analyzing the heat map to detect thermal variations that exceed a thermal variation threshold value to detect a microcrack.

11. The method of claim 10, wherein generating the heat map comprises generating a visual representation of the collected thermal data with a precision of five microns.

12. The method of claim 11, wherein the precision of five microns facilitates detection of internal cracks as small as ten microns.

13. The method of claim 10, wherein the electrical current is in a range between ten microamps (μA) and one hundred μA.

14. The method of claim 10, wherein the thermal variations are identified based, at least in part, by comparing a temperature reading to a baseline temperature.

15. The method of claim 10, wherein positioning the plurality of probes on the at least one semiconductor die comprises positioning a first probe of the plurality of probes proximate an edge of the at least one semiconductor die and positioning a second probe of the plurality of probes proximate a center of the at least one semiconductor die.

16. A system, comprising:
means for inducing localized heating of a semiconductor die;
means for measuring a surface temperature the semiconductor die;
means for generating a heat map based, at least in part, on the surface temperature of the semiconductor die; and
means for analyzing the heat map to detect a crack within the at least one memory die.

17. The system of claim 16, wherein the means for inducing localized heating of the semiconductor die comprise a plurality of conductive probes.

18. The system of claim 16, wherein the means for measuring the surface temperature of the semiconductor die comprise at least one thermal sensor.

19. The system of claim 16, wherein the means for analyzing the heat map to detect a crack within the semiconductor die detects cracks as small as ten microns.

20. The system of claim 16, wherein the crack is detected based, at least in part, on a comparison between a temperature reading of an area of the semiconductor die to a baseline temperature.
